(19) United States
(12) Patent Application Publication
(10) Pub. No.: US 2020/0068370 A1
(43) Pub. Date: Feb. 27, 2020

(54) METHOD, APPARATUS AND SYSTEM FOR INTELLIGENT CALLING SERVICE

(71) Applicant: Keenstar Corporation, Taipei City (TW)

(72) Inventors: LI-WEN LIAO, Taipei City (TW); YEN-TING HO, Taipei City (TW); WAN-CHEN CHEN, Taipei City (TW)

(21) Appl. No.: 16/112,995

(22) Filed: Aug. 27, 2018

(51) Int. Cl. H04W 4/70; H04W 4/02; H04W 4/029; H04W 4/06; H04W 4/80

(52) U.S. Cl. CPC H04W 4/70; H04W 4/023; H04W 4/80; H04W 4/06; H04W 4/029

(57) ABSTRACT

The disclosure is related to a method for intelligent calling service, an apparatus and a system thereof. The method is performed in a server. When the server receives a service request signal recording a device ID generated by an apparatus for intelligent calling service, call information of service personnel can be obtained based on a service location corresponding to the device ID by querying a database of the server. After that, the server issues a service call signal to service communication devices carried by the service personnel. When a distance between the service communication device and the apparatus for intelligent calling service reaches a threshold, it shows that one of the service personnel is in service. This calling service procedure is done when the server receives a dismissing signal generated by the apparatus or the service communication device near the apparatus.

### FIELD OF THE DISCLOSURE

The disclosure is related to a method for a calling service, in particular to a method, a system and an apparatus for intelligent calling service using a server to perform service notifications and service management.

### BACKGROUND OF THE DISCLOSURE

Advancement in communication technology drives the development of the Internet of Things (IoT). The development of IoT is reflected in applications such as sensors disposed at various locations of a place. With those sensors, users can be made aware of certain events that occur in the place. For example, information related to temperature, electricity and light of the place can be acquired through the sensors, so that follow-up procedures, i.e., measures that are executed according to the information acquired by the sensors, can be performed.

IoT-based devices are usually associated with an automatic procedure. For example, a motion sensor can be disposed at an entrance of a bank, a restaurant or a mall providing services, to sense entering or exiting people. When the motion sensor senses people entering, the system of the sensor will send out a notification such as a service bell or voice such that service personnel in the place can provide timely services.

However, many IoT applications lack interaction with customers. Although the users can be made aware of some events through the sensors, no customer service procedures are incorporated therein.

### SUMMARY OF THE DISCLOSURE

The disclosure is related to a method, an apparatus and a system for intelligent calling service. An automatized service procedure is provided for integrating hardware and software so as to provide service to a site. The service procedure is completed by combining a service request and a calling service.

According to one embodiment of the system for the intelligent calling service, the system integrates the hardware such as service communication devices carried by service personnel, a plurality of apparatuses at service locations and a server. The service communication device is an electronic device carried by a person of the service personnel, and can be a portable device, e.g. a wristband. The apparatus for the intelligent calling service is a terminal device that can be controlled by a customer. The server performs a method for the intelligent calling service. The server can be performed in a server host or embedded in a terminal device.

In the beginning, the server receives a service request signal from one of the apparatuses for the intelligent calling service. The service request signal records a device ID with respect to the apparatus. The device ID is used to identify one of the service locations at a service site. Then, call information corresponding to one or more persons of the service personnel can be acquired by querying a service personnel database according to the device ID. The software running in the server is used to issue a calling service signal to the service communication devices carried by the service personnel, and the calling service signal is associated with the service location. One of the service personnel receives the calling service signal, and then goes to the service location to provide service. When a distance between the service communication device and the apparatus generating the service request signal reaches a threshold, the service will receive a dismissing signal.

In one embodiment of the disclosure, the apparatus for the intelligent calling service includes a control unit and a trigger unit allowing the customer to trigger a generation of a service request signal. The apparatus includes a communication unit that is used to communicate with the server to transmit the service request signal to the server. The apparatus for the intelligent calling service includes a proximity sensor unit that is used to calculate a distance between the service communication device and the apparatus. In one embodiment, the distance between the apparatus and the service communication device carried by the service personnel is calculated through a received signal strength indicator (RSSI).

In the method for the intelligent calling service, the server receives a service request signal from an apparatus. A device ID in the service request signal corresponds to a service location. The server queries a service personnel database according to the device ID to acquire call information related to one or more persons of service personnel. The server then issues a calling service signal to the service communication device(s).

If the distance between the service communication device carried by the service personnel and the apparatus reaches a threshold, one of the devices will generate a dismissing signal indicating that the service personnel has reached the service location to notify the server that the intelligent calling service has been completed.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings, in which:

FIG. 1 shows a schematic diagram of a system for intelligent calling service according to one embodiment of the disclosure;

FIG. 2 shows a schematic diagram of electrical units of each apparatus in the system for the intelligent calling service according to the present disclosure;

FIG. 3 shows a flow chart of a method for the intelligent calling service according to one embodiment of the disclosure;

FIG. 4 shows a flow chart of the method for the intelligent calling service according to another embodiment of the disclosure;

FIG. 5 shows a flow chart of the method for the intelligent calling service according to another embodiment of the disclosure;

FIG. 6 shows a flow chart of the method for the intelligent calling service according to another embodiment of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The disclosure is related to a method, an apparatus and a system for intelligent calling service. The system can be applied to a site that requires customer services such as a bank, a mall, a restaurant, a healthcare center, an aircraft or a cruise ship, or even places that require security service. When a customer enters these places and needs face-to-face service, the customer can trigger an apparatus for intelligent calling service. The apparatus can be a service bell, a touch device or a computer device that can send a message. A server of the site notifies the service personnel in charge of the site according to a location of the apparatus for the intelligent calling service to send a service request thereto.

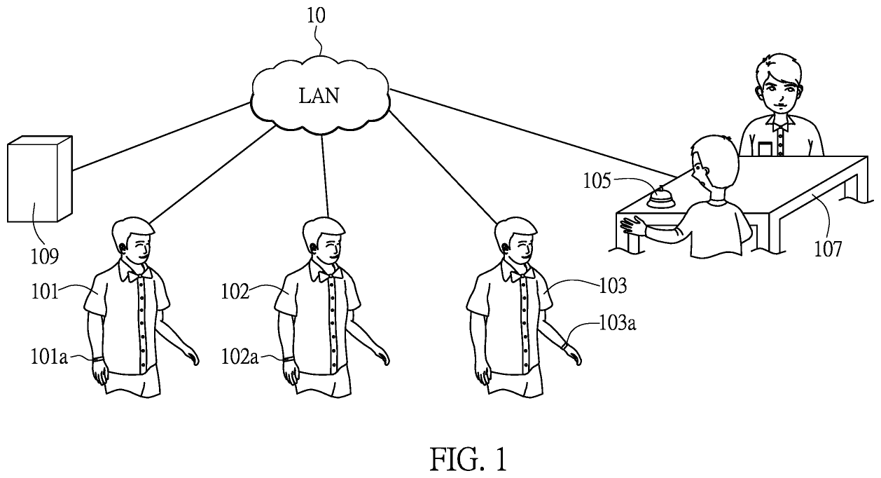

According to the embodiment of the system for the intelligent calling service, the system includes the server, the apparatus for the intelligent calling service and a portable device of the service personnel. The server can be a standalone server host as shown in FIG. 1. The server can also be a software program embedded in a terminal device capable of processing data or a software program operated in a Point of Sale (POS) of a business location. The server can communicate with the apparatus and the service communication device carried by the service personnel via a local area network (LAN) such as the Internet, WiFi™ or other network with near-field communication protocol. It should be noted that the apparatus for the intelligent calling service can be, but is not limited to, a service bell in a broad sense.

The system for the intelligent calling service provides measures for managing responsibilities or accountability at the site. The server assigns dedicated service personnel for different events, different areas, or different locations. A job substitute can be set up in the server. Further, a service queue can also be set in the server for more than one of the service personnel in areas of overlapping responsibility. For example, if a preset service personnel responsible for a specific area is, whether actively or passively, unable to provide service, the system will automatically call a substitute for the unavailable service personnel according to the service queue.

Reference is made to FIG. 1. FIG. 1 shows a schematic diagram of a system for the intelligent calling service in one embodiment of the disclosure. The system for the intelligent calling service is a solution integrating software and hardware functionalities. The hardware is such as the service communication devices carried by the service personnel, e.g. waiters 101, 102 and 103. The service communication device can refer to an intelligent wristband such as portable devices 101a, 102a and 103a shown in FIG. 1. The service communication device can also be a mobile phone, a tablet computer, smart glasses or other types of portable devices.

The system includes a plurality of the apparatuses for the intelligent calling service disposed at a plurality of service locations. For example, as shown in FIG. 1, a service location 107 is a table or a specific place at a restaurant, and several consumers are around the service location 107. An apparatus for the intelligent calling service 105 can be a service bell, an ordering device or a computer device capable of displaying messages.

The server is operated in a server host 109 that communicates with the apparatus for the intelligent calling service 105 and the portable devices 101a, 102a and 103a via a LAN 10. A processing unit of the server host 109 executes the software program stored in a memory to perform the method for the intelligent calling service.

In this example, the consumers around the service location 107 uses the apparatus 105 to generate a service request signal. The service request signal records a device ID associated with the apparatus 105. The device ID allows the software program in the server host 109 to obtain the service location 107 by querying a database. The software program running in the server host 109 receives the service request signal via the LAN 10. A person of the service personnel corresponding to the service location 107 can be obtained by querying a service personnel database based on the device ID. After querying the database, call information of one or more persons of the service personnel 101, 102 and 103 can be obtained by the database query. In the example, the call information is such as a communication ID associated with the portable devices 101a, 102a and 103a. The communication ID can be an IP address, a number or a MAC address. The server host 109 can issue a calling service signal to part of or all the portable devices 101a, 102a and 103a by a specific communication protocol.

After that, one of the service personnel 101, 102 and 103 arrives at the service location 107 to provide the service. A distance between the service communication device, e.g. one of the portable devices 101a, 102a and 103a, carried by the service personnel and the apparatus 105 that generates the service request signal is calculated. When the distance reaches a threshold, one of the portable devices 101a, 102a and 103a or the apparatus 105 generates a dismissing signal. The dismissing signal is then transmitted to the server host 109, completing this procedure for the calling service.

In one embodiment of the disclosure, the apparatus 105 can be disposed in a restaurant kitchen. The device ID associated with the apparatus 105 corresponds to the position of the kitchen. The service request signal generated by the apparatus 105 may include information related to a service location where a chef chooses to deliver the dish and a time limit set for this service procedure. The server host 109 starts a timer when performing the calling service procedure. The software program running in the server host 109 determines that the dish is delivered from the kitchen and the service location is obtained. According to a service personnel list in the service person database used to identify the service personnel, the service host 109 issues a calling service signal to ask the service personnel to deliver the dish from the kitchen to the service location, e.g. the table, within the time limit.

Further, the software program running in the server host 109 can set up functions of notification and reminder. The system can remind the service personnel to provide the service within a time limit through the service host 109 when a customer arrives at the service location. Furthermore, the system can also set up a time to remind the customers of the information such as a mealtime, a closing time, a special offer or a special program by the service personnel.

In the services operated in the server host 109, in addition to issuing the calling service signal to the service personnel according to the service personnel list, the system can further notify all or part of the service personnel. In the example of the restaurant service, the system can notify all or part of the service personnel of messages through the server host 109. The message is exemplified as ‘certain dishes are sold out’, ‘new dishes’, ‘new special offer’, ‘closing time’, ‘equipment inspection’, or ‘checking stock.’

In one embodiment, the server originally running in the server host 109 can be a software-enabled server embedded in one of the terminal devices if the capabilities of a processor and the memory of the terminal device, e.g. the portable device or the apparatus for the intelligent calling service, reach a certain level.

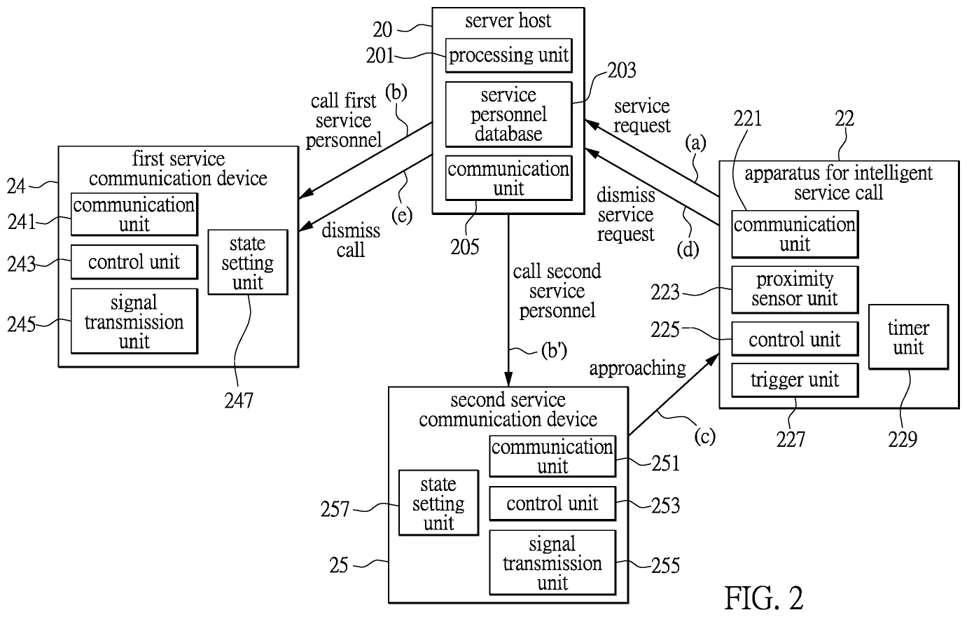

FIG. 2 shows a schematic diagram of electrical units of each apparatus in the system for the intelligent calling service according to embodiment of disclosure. A server host 20 implements the server of the system. The server host 20 includes a processing unit 201, a service personnel database 203 and a communication unit 205. The main circuit components of the apparatus 22 include a communication unit 221, a proximity sensor unit 223, a control unit 225, a trigger unit 227 and a timer unit 229. In this embodiment, the portable devices worn on the service personnel are a first service communication device 24 and a second service communication device 25. The first and second service communication devices 24 and 25 respectively include control units 243 and 253 and communication units 241 and 251 electrically connected with the control units 243 and 253, signal transmission units 245 and 255 and state setting units 247 and 257.

The control unit 225 of the apparatus 22 is such as a micro-controller that is mainly used to process the triggered service event including generating the service request signal, calculating a distance between the apparatus 22 and the first service communication device 24 or the second service communication device 25 based on a received signal strength indicator (RSSI), and ending the calling service if the distance satisfies a preset condition.

In one embodiment, the apparatus 22 has the trigger unit 227 that can be a service bell, a touch button, or other way to trigger the calling service. For example, a voice signal can be used to generate the service request signal. The trigger unit 227 is electrically connected with the control unit 225. Once the trigger unit 227 is triggered, the control unit 225 is driven to generate the service request signal.

Further, the apparatus 22 has the communication unit 221, electrically connected with the control unit 225, used to conduct a wired or wireless communication protocol for connecting with the server host 20. Through this communication unit 221, the service request signal is transmitted to the server host 20. The server host 20 can acquire the device ID and the call information of the one or more service personnel associated with the device ID.

Still further, the apparatus 22 has a proximity sensor unit 223 that is configured to perform a specific near-field wireless communication protocol. The proximity unit 223 is electrically connected with the control unit 225. The proximity unit 223 is used to calculate the distance between the service communication device, e.g. the first service communication device 24 or the second service communication device 25, and the apparatus 22.

In an exemplary example, the proximity sensor unit 223 allows the apparatus 22 to broadcast communication packets periodically. The first service communication device 24 or the second service communication device 25 can also broadcast communication packets periodically. The proximity sensor unit 223 obtains the RSSI through the transmitted and received packets. It should be noted that the RSSI can be regarded as a distance between the two devices. When the distance reaches a distance threshold, the dismissing signal is generated by the apparatus 22 or the service communication device, and the dismissing signal is transmitted to the server host 20 therefrom.

Further, a technology of near field communication (NFC) can be introduced to calculate the distance between the apparatus 22 and first service communication device 24 or the second service communication device 25. More, Bluetooth™ technology or other near-field wireless communication technology can also be used in the system. When the distance between the apparatus 22 and the service communication device 24 or 25 reaches a preset distance threshold, the communication protocol there-between allows the two devices to exchange the packets. The server host 20 generates the dismissing signal if the distance satisfies a preset condition.

In the method for the intelligent calling service of the disclosure, when the service personnel arrives at the service location within a distance and starts a service, a dismissing signal is generated. The dismissing signal can be generated automatically or manually by the consumer or the service personnel operating the apparatus 22 or the service communication device so as to end the calling service.

The apparatus 22 includes a timer unit 229 that is electrically connected with the control unit 225. The timer unit 229 is activated to count the time when the apparatus 22 generates the service request signal. If no service personnel arrives at the service location when the time reaches a time threshold, the apparatus 22 may re-issue the service request signal to the server to remind the service personnel.

According to the embodiment shown in the diagram of FIG. 2, in the method for the intelligent calling service, the process begins when the apparatus 22 issues a service request signal (a) to the server host 20. The server host 20 receives this service request signal (a) by the communication unit 205. After the processing unit 201 of the service host 20 processes the request, the service personnel corresponding to the service location associated with the request can be obtained by querying the service personnel database 203 according to the device ID of the apparatus 22.

Next, the server host 20 issues calling service signals (b) and (b′) to both the first service communication device 24 and the second service communication device 25 by the communication unit 205. In the present example, the calling service signal (b) is transmitted to the first service communication device 24 carried by a first person of the service personnel. In the meantime, the calling service signal (b′) is transmitted to the second service communication device 25 carried by a second person of the service personnel.

After that, when the second person of the service personnel carrying the second service communication device 25 receives this instruction, the second person of the service personnel arrives at the location with the apparatus 22. The second person of the service personnel approaches the apparatus (22) in a distance (c). When the distance (c) between the apparatus 22 and the second service communication device 25 reaches a threshold, the apparatus 22 may generate a dismissing signal (d) automatically. The apparatus 22 transmits the dismissing signal (d) to the server host 20 for dismissing the service request. The server host 20 then transmits a dismiss calling service signal (e) to another service personnel, i.e. the first service personnel, carrying the first service communication device 24 through the communication unit 205. This action is to end the present calling service and notify the other service personnel(s) not to go to the service location in this process.

Both the service communication devices 24 and 25 can be an electronic device. The communication units 241 and 251 of the service communication device 24 and 25 are used to process the signals generated by the server host 20 by the communication protocol such as WiFi™, Bluetooth™ or the like so as to generate the communication packets exchanged with the apparatus 22 for intelligent calling service. Signal transmission units 245 or 255 of the service communication devices 24 and 25 perform a specific wireless communication protocol for exchanging packets with the apparatus 22. An RSSI is introduced to calculate the distance therebetween. Further, both the first service communication device 24 and the second service communication device 25 have the state setting units 247 and 257 respectively. The state setting units 247 and 257 can be a physical button or a touch interface that is provided for the service personnel to set the state when receiving the calling service signal. For example, the service personnel can set the state as accepting the calling service when being near the service location. On the contrary, the service personnel can set the state as rejecting the calling service through the state setting unit 247 or 257 when being too busy to be at the service location in time. When receiving a state set as acceptance from one of the service personnel, the server host 20 will notify the other persons of the service personnel that someone has already started the service. On the other hand, the server host 20 otherwise notifies the next person of the service personnel in the service queue according to the service personnel list if the person of the service personnel listed first in the service queue rejects the current calling service.

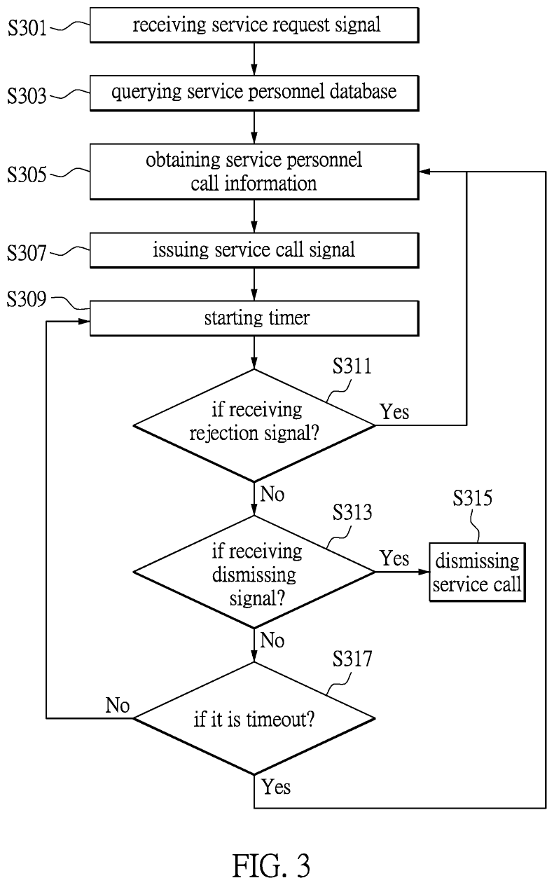

The method for the intelligent calling service according to one embodiment is described in a flow chart of FIG. 3.

In the beginning, such as in step S301, the server receives the service request signal from the apparatus for the intelligent calling service. In step S303, the software program running in the server acquires the device ID of the apparatus from the service request signal. Accordingly, one or more service personnel corresponding to the service location associating with the device ID can be obtained by querying the service personnel database. The information obtained from the service personnel database can include the substitute service personnel. In step S305, the call information with respect to the service personnel can also be obtained by querying the database. The call information is such as the communication ID associated with the service communication device carried by the service personnel.

The mentioned service personnel list records the relationship of substitution among the service personnel. According to the service personnel list, the system can obtain one or more persons of the service personnel for a calling service event. The server then issues the calling service signal to the service communication devices carried by the service personnel according to the service location. The server also records the updated state of each service personnel and makes a comprehensive determination based on the states of all the service personnel. In an exemplary example, the server determines a service personnel listed first in the service queue by excluding the possible reasons causing the service personnel not to provide the service in time. The determination of the service personnel for the calling service may be based on the state of the service personnel such as on leave, idle, out of range, incapacitated, the customer's characteristics, service item, dismissed, or already in service.

When the server issues the calling service signal, such as in step S309, the timer will be reset and starts to count the time for the current calling service. It should be noted that the time limitation for various service items can be different. In step S311, the server constantly determines whether or not a rejection signal from the service personnel is received within the time limit.

If the server receives a rejection signal, step S305 will be repeated for acquiring the call information with respect to the service personnel and look for the next person of the service personnel in the service queue based on the updated state and the characteristics of the service personnel. Again, the server will issue a new calling service signal (step S307) and re-starts the timer with a new time limit or continues the timer (step S309).

When the server does not receive any rejection signal, in step S313, the server determines whether or not the dismissing signal is received from the apparatus or the service communication device. If the server does receive the dismissing signal within the time limit, it shows that the service personnel has arrived the service location and the current calling service would be completed by dismissing the service request (step S315). Otherwise, if the server does not receive the dismissing signal, the process goes to step S317 to determine if the server is timed out. The process goes on step S309 for continuing the timer if the server is not timed out. In the meantime, the process determines whether or not the rejection signal (step S311) or the dismissing signal is received (step S313).

When the process is timed out, it shows that no service personnel has arrived at the service location in time during this calling service. The step S305 is repeated for re-acquiring the service personnel that is next in queue in the service queue by re-issuing the calling service signal, re-activating the timer and other steps in the process. It should be noted that the service personnel that is next in queue in the service queue may be the service personnel who had been called in the previous process.

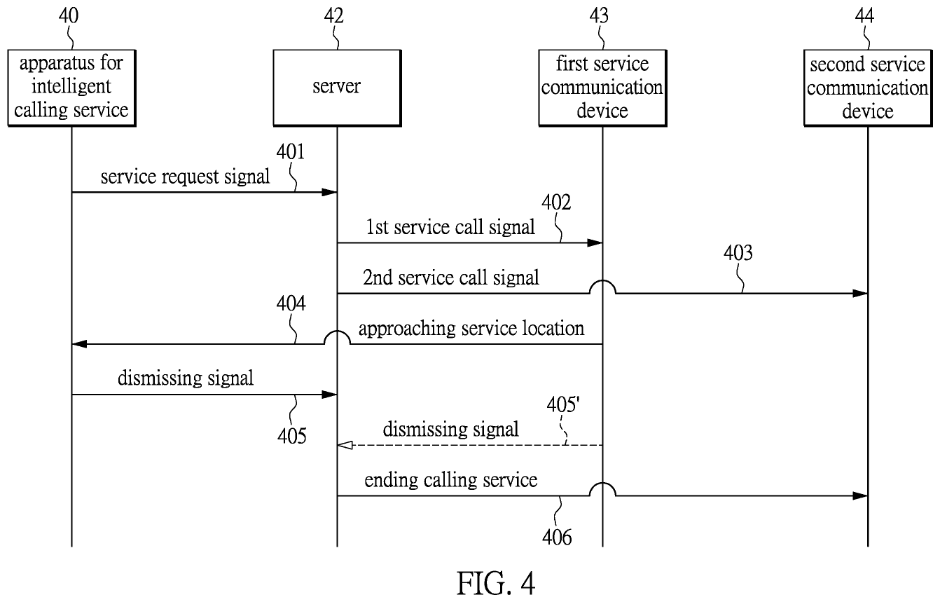

FIG. 4 to FIG. 6 show the flow charts describing the method for the intelligent calling service according to the embodiments of the disclosure.

In FIG. 4, in the beginning, an apparatus 40 that is located at the service location generates a service request signal (step 401). A server 42 then receives the service request signal, and obtains the service location and at least one associated person of the service personnel by looking up the service personnel database. In the present case, the server 42 issues a first calling service signal to a first service communication device 43 (step 402), and simultaneously issues a second calling service signal to a second service communication device 44 (step 403).

After that, the first service communication device 43 approaches the apparatus 40 that generates the service request signal, namely, the service personnel approaches the service location (step 404). The apparatus 40 then generates the dismissing signal when a distance between the apparatus 40 and the first service communication device 43 reaches a threshold (step 405). In one further aspect, the dismissing signal can be generated by the first service communication device 43 (step 405′). The dismissing signal is a message notifying the server 42 that the service personnel has already arrived the service location and started the service. In the meantime, the server 42 will notify the second service communication device 44 that the calling service process is ended (step 406).

It should be noted that the abovementioned server 42, or an agent program or an agent node, the apparatus 40, the first service communication device 43 and the second service communication device 44 constitute a network system, e.g. an LAN, and this network system can be a Bluetooth Low Energy (BLE) mesh network that is suitable for IoT. The nodes within the LAN can be communicated with each other via a BLE communication protocol.

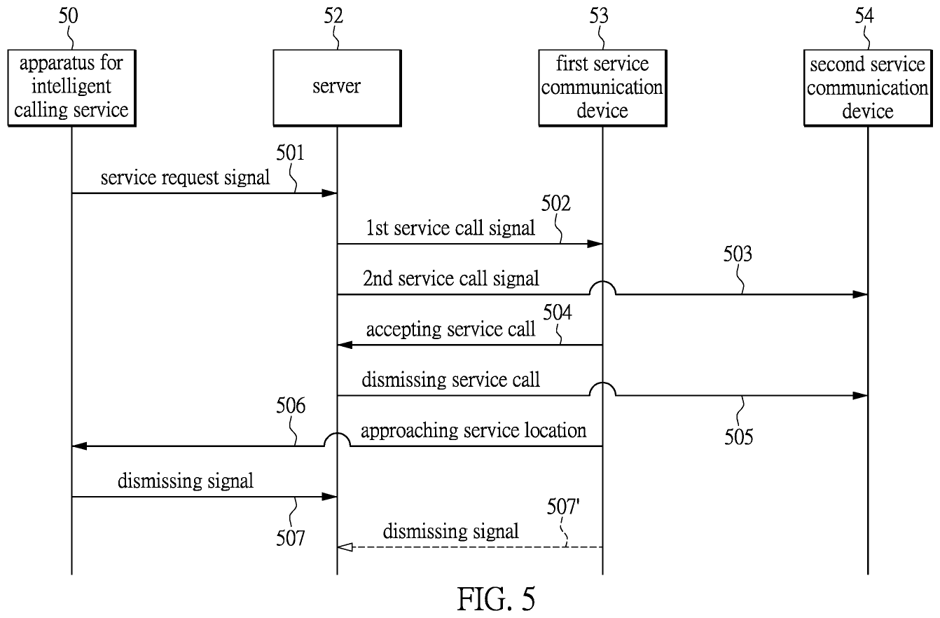

In FIG. 5, an apparatus 50 first generates the service request signal (step 501, and transmits the signal to a server 52. The server 52 looks up the call information with respect to a first service communication device 53 and a second service communication device 54 based on the service location associating with the device ID carried in the service request signal. The server 52 then transmits the first calling service signal and the second calling service signal respectively to the first service communication device 53 (step 502) and the second service communication device 54 (step 503).

In the present example, the service personnel carrying the first service communication device 53 sets the device as being able to accept the notification of the calling service from the server 52 (step 504). The server 52 then notifies the second service communication device 54 to end the current calling service (step 505). Next, the service personnel carrying the first service communication device 53 walks to the service location and approaches near the apparatus 50 (step 506). When the distance reaches a threshold, the apparatus 50 for the intelligent calling service generates the dismissing signal (step 507), or the first the service communication device 53 generates the dismissing signal (step 507′). The server 52 will be notified that the service has begun.

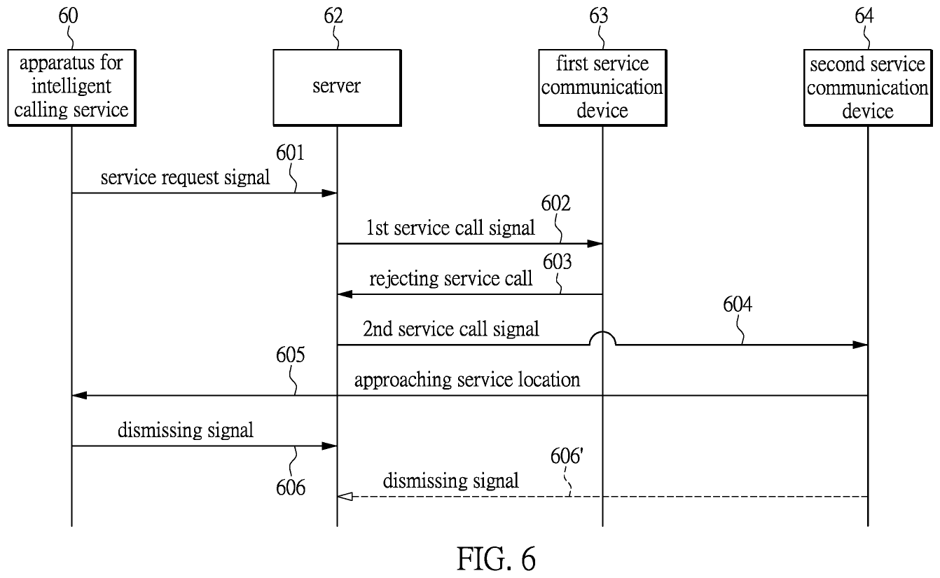

FIG. 6, other than the embodiments described in the flows of FIG. 4 and FIG. 5, shows that the server issues the calling service to multiple persons of the service personnel at the same time. In the beginning, an apparatus 60 for the intelligent calling service generates the service request signal to a server 62 (step 601). The server 62 queries the database to acquire the person of the service personnel listed first in the service queue who carries a first service communication device 63. The server 62 then issues the first calling service signal to the first service communication device 63 (step 602). However, if the person of the service personnel is delayed for some reason and cannot go to the service location, the person can set the first service communication device 63 to generate a notification of rejecting the calling service to notify the server 62 (step 603). The server 62 then issues the second calling service signal to a second service communication device 64 carried by a person of the service personnel listed second in the service queue obtained by querying the database (step 604). The present example shows that the person of the service personnel listed second in the service queue is available to go to the service location and approaches the apparatus 60 (step 605). When the distance reaches a threshold, the apparatus 60 for the intelligent calling service generates the dismissing signal (step 606), or the second the service communication device 64 generates the dismissing signal (step 606′) to end the calling service.

It should be noted that the server of the system may not be limited to the program in a computer host or POS (Point of Sale), but can be a software program running in other kinds of terminal devices. The server provides the service personnel database that can be a lookup table for recording the device IDs associated with apparatuses for the intelligent calling service, the corresponding service locations, and the call information of the one or more service personnel related to the service locations. When each of the service locations corresponds to multiple persons of the service personnel, the service personnel database is configured to record the service queue of the multiple persons of the service personnel with respect to every service location. While generating a service request, the system calls one of the service personnel according to the service queue. The server may call the service personnel that is next in queue if the person of the service personnel listed first rejects the call or the call is timed out. At last, a supervisor may handle the event if no service personnel is able to go to the service location. Under a specific circumstance, the server may call multiple persons of the service personnel to provide the service together. Alternatively, the service personnel is free to decide whether or not to accept or reject the calling service.

In sum, the system for the intelligent calling service of the disclosure can provide more convenient and intelligent services at a site that requires service. The POS or the server can continuously collect big data from the system, for example the time for serving the customers, the status of equipment, and the preferences of customers. The server can accordingly adjust the service personnel list since the preferences of customers can be used to optimize the service. Further, the apparatus for the intelligent calling service can be the IoT device such as the sensor disposed at the site. The apparatus can be connected with a security system. The server can produce big data used to improve the service, the service quality and provide customized service.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for intelligent calling service, performed in a server, comprising:
receiving a service request signal generated by an apparatus for the intelligent calling service, wherein the service request signal records a device ID of the apparatus;
querying a service personnel database according to the device ID to acquire call information of one or more service personnel corresponding to the device ID;
issuing a service call signal to one or more service communication devices carried by the one or more service personnel; and
the server receiving a dismissing signal when a distance between the service communication device of one of the service personnel and the apparatus that generates the service request signal reaches a threshold.

2. The method as recited in claim 1, wherein the distance between the service communication device carried by the service personnel and the apparatus for the intelligent calling service is calculated according to a received signal strength indicator.

3. The method as recited in claim 1, wherein the service personnel database records a service location corresponding to the device ID of the apparatus for the intelligent calling service, and the call information of the one or more service personnel with respect to the service location; wherein the call information of each of the service personnel is a communication ID of the service communication device.

4. The method as recited in claim 3, wherein the distance between the service communication device carried by the service person and the apparatus for intelligent service call is calculated according to a Received Signal Strength Indicator.

5. The method as recited in claim 3, wherein, when each service location corresponds to multiple service personnel, the service personnel database records a service queue of the multiple service personnel with respect to the service location.

6. The method as recited in claim 5, wherein, when the service personnel listed first in the service queue receives the service call signal, the service communication device carried by the person of the service personnel generates a rejection signal and the server issues the service call signal again to the service personnel next in queue in the service queue.

7. The method as recited in claim 5, wherein, when the person of the service personnel listed first in the service queue receives the service call signal, the server starts a timer; when the server does not receive the dismissing signal as the time reaches a time threshold, the server issues the service call signal to the service personnel next in queue in the service queue.

8. The method as recited in claim 5, wherein the server issues the service call signal to all the service communication devices carried by the service personnel corresponding to the service location; the service issues a dismiss service call signal to other service personnel when the server receives the dismissing signal from one of the service personnel.

9. The method as recited in claim 8, wherein the distance between the service communication device carried by the service personnel and the apparatus for the intelligent calling service is calculated according to a received signal strength indicator.

10. The method as recited in claim 9, wherein the dismissing signal is generated by the apparatus for the intelligent calling service or the service communication device, and the dismissing signal is transmitted to the server therefrom.

11. An apparatus for intelligent calling service, comprising:
a control unit;
a trigger unit, electrically connected to the control unit, and after being triggered, generating a service request signal;
a communication unit, electrically connected to the control unit, used to connect with a server and transmit the service request signal to the server; wherein, the service request signal records a device ID of the apparatus for the intelligent calling service, and the server records call information of one or more service personnel corresponding to the device ID;
a proximity sensor unit, electrically connected with the control unit, used to calculate a distance between a service communication device carried by each of the service personnel and the apparatus;
wherein, when the apparatus for the intelligent calling service generates the service request signal and transmits the service request signal to the server, the server issues a service call signal to one or more service communication devices carried by the one or more service personnel; a dismissing signal is generated by one of the service communication devices and transmitted to the server when the distance between the service communication device carried by one of the service personnel and the apparatus reaches a threshold.

12. The apparatus as recited in claim 11, wherein the distance between the service communication device carried by the service personnel and the apparatus for intelligent calling service is calculated according to a received signal strength indicator.

13. The apparatus as recited in claim 11, wherein the service personnel database records a service location corresponding to the device ID of the apparatus for the intelligent calling service, and the call information of the one or more service personnel with respect to the service location; wherein the call information of each person of the service personnel is a communication ID of the service communication device.

14. The apparatus as recited in claim 13, wherein the distance between the service communication device carried by the service personnel and the apparatus for the intelligent calling service is calculated according to a received signal strength indicator.

15. The apparatus as recited in claim 11, wherein the dismissing signal is generated by the apparatus for the intelligent calling service or the service communication device, and the dismissing signal is transmitted to the server therefrom.

16. A system for intelligent calling service, comprising:
a plurality of service communication devices carried by a plurality of service personnel;
a plurality of apparatuses for the intelligent calling service disposed at a plurality of service locations; and
a server having a processing unit that is used to execute a method for the intelligent calling service, the method including:
receiving a service request signal generated by one of the apparatuses for the intelligent calling service, and the service request signal records a device ID of the apparatus;
querying a service personnel database according to the device ID to acquire call information of one or more service personnel corresponding to the device ID;
issuing a service call signal to one or more service communication devices carried by the one or more service personnel; and
wherein, the server receives a dismissing signal when a distance between the service communication device carried by one of the one or more persons of the service personnel and the apparatus that issues the service request signal reaches a threshold.

17. The system as recited in claim 16, wherein the distance between the service communication device carried by the service personnel and the apparatus for the intelligent calling service is calculated according to a received signal strength indicator.

18. The system as recited in claim 16, wherein the service personnel database records a service location corresponding to the device ID of the apparatus for the intelligent calling service, and the call information of the one or more service personnel with respect to the service location; wherein the call information of each of the service personnel is a communication ID of the service communication device.

19. The system as recited in claim 18, wherein the server issues the service call signal to all the service communication devices carried by the service personnel corresponding to the service location; the service issues a dismiss service call signal to other service personnel when the server receives the dismissing signal from one of the service personnel.

20. The system as recited in claim 19, wherein the dismissing signal is generated by the apparatus for the intelligent calling service or the service communication device, and the dismissing signal is transmitted to the server therefrom.
